(19) United States
(12) Patent Application Publication
(10) Pub. No.: US 2009/0090032 A1
(43) Pub. Date: Apr. 9, 2009

(54) APPARATUS AND METHOD FOR MEASURING AND CONTROLLING THE ANGLE OF A SNOW PLOW BLADE

(75) Inventors: Aiqi Yang, Charlotte, NC (US); Colin J. Casey, Fort Wayne, IN (US)

Correspondence Address: International Truck Intellectual Property Company,, 4201 WINFIELD ROAD, WARRENVILLE, IL, 60555, US

(73) Assignee: International Truck Intellectual Property Company, LLC, Warrenville, IL (US)

(21) Appl. No.: 11/868,715

(22) Filed: Oct. 8, 2007

(51) Int. Cl. E01H 5/06; E01H 5/00; G06F 17/00

(52) U.S. Cl. 37/234; 37/270; 701/50

(57) ABSTRACT

A plow blade assembly (24) and a position adjustment system includes a plow blade (26) mounted to a frame (14) of a vehicle (10), and an actuator (52) for adjusting the position of the plow blade relative to the frame of the vehicle. The actuator (52) includes a blade position sensor (34) for sensing an actual position of the plow blade (26) and inputting the actual blade position to a computer (44), and a user input receiver (50) for the user to input a desired position of the plow blade to the computer. The computer (44) compares the actual position to the desired position and causes the actuator (52) to move the plow blade (26) to the desired position without user intervention.

### FIELD OF THE INVENTION

The present invention relates generally to snow removal vehicles, and more particularly, to an apparatus and method for measuring and controlling a snow plow blade.

### BACKGROUND OF THE INVENTION

Snow removal vehicles typically include a plow blade that is mounted beneath the vehicle frame, either in front of the vehicle or between the front and rear wheels. In both the front-mounted and the underbody-mounted configurations, it can be difficult to see the plow blade from the driver's cab. Specifically, in a snow removal vehicle where the plow blade is mounted between the front and rear wheels, the plow blade is out of the driver's line of sight while the driver is facing the forward direction, requiring the driver to periodically turn around to look at the plow blade.

On a conventional snow removal vehicle, the angle of attack of the plow blade is variable depending on the speed of the vehicle, and the characteristics and location of the snow. Since these conditions can change during operation of the snow removal vehicle, the plow blade can require frequent adjustment. The driver typically adjusts the plow blade manually with a lever or joystick located in the driver's cab while visually monitoring the plow blade.

Since the driver must operate the lever and visually monitor the plow blade while operating the snow removal vehicle, the driver's attention can be diverted from driving the vehicle. In addition, the driver is often operating the snow removal vehicle in poor road conditions. The poor driving conditions and the manual adjustment of the plow blade provide an opportunity to improve the safety of the snow removal vehicle operation.

### SUMMARY OF THE INVENTION

A plow blade assembly and a position adjustment system includes a plow blade mounted to a frame of a vehicle, and an actuator for adjusting the position of the plow blade relative to the frame of the vehicle. The actuator includes a position sensor for sensing an actual position of the plow blade and inputting the actual blade position to a computer, and a user input receiver for the user to input a desired position of the plow blade to the computer. The computer compares the actual position to the desired position and causes the actuator to move the plow blade to the desired position without user intervention.

### BRIEF DESCRIPTION OF THE DRAWINGS

FIG. 1 is a right side plan view of a snow removal vehicle having a snow plow blade in accordance with the invention.

FIG. 2 is a flowchart of a position feedback control system for measuring and controlling the snow plow blade on the snow removal vehicle in accordance with the invention.

FIG. 3 is a driver display of the control system for the snow removal vehicle in accordance with the invention.

FIG. 4 is a front perspective view of an underbody-mounted plow blade assembly having a position sensor in accordance with the invention.

FIG. 5 is a rear perspective view of a front-mounted plow blade assembly having two position sensors in accordance with the invention.

### DESCRIPTION OF A PREFERRED EMBODIMENT

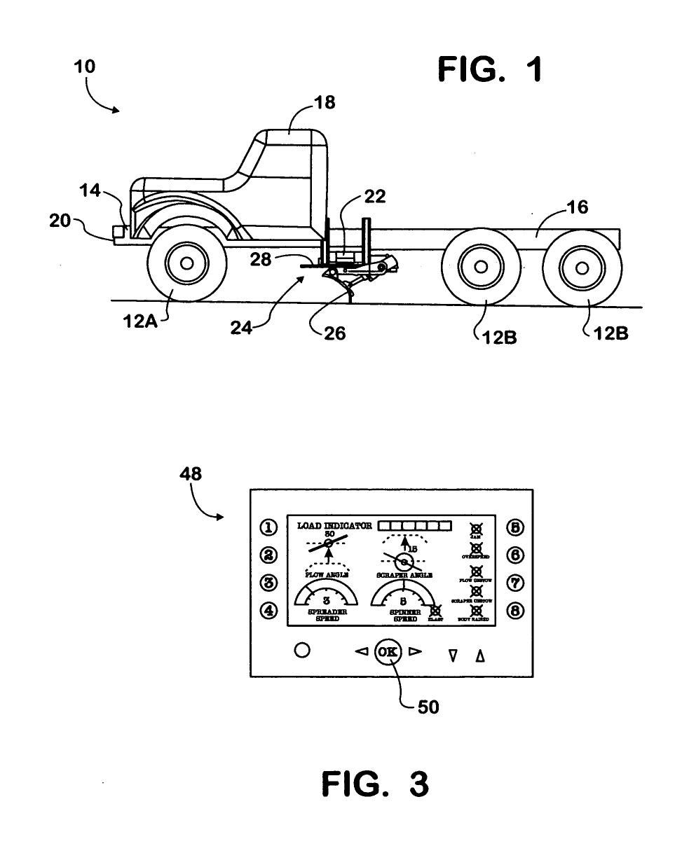

Referring to FIG. 1, a snow removal vehicle is indicated generally at 10 and includes a plurality of wheels 12 mounted on a frame 14. As is known in the art, the frame 14 includes two siderails 16 that extend longitudinally along the length of the snow removal vehicle 10, and a plurality of cross-members (not shown). A driver's cab 18 is positioned on the frame 14 towards a front end 20 of the snow removal vehicle 10.

At least one scraper-mounting bracket 22 extends generally perpendicularly from the frame 14 for attaching a plow blade assembly 24 to the vehicle 10. In the embodiment of FIG. 1, the plow blade assembly 24 is mounted under the frame 14 between the front wheels 12A and the rear wheels 12B, however, it is contemplated that the plow blade assembly can be mounted in front of the front wheels.

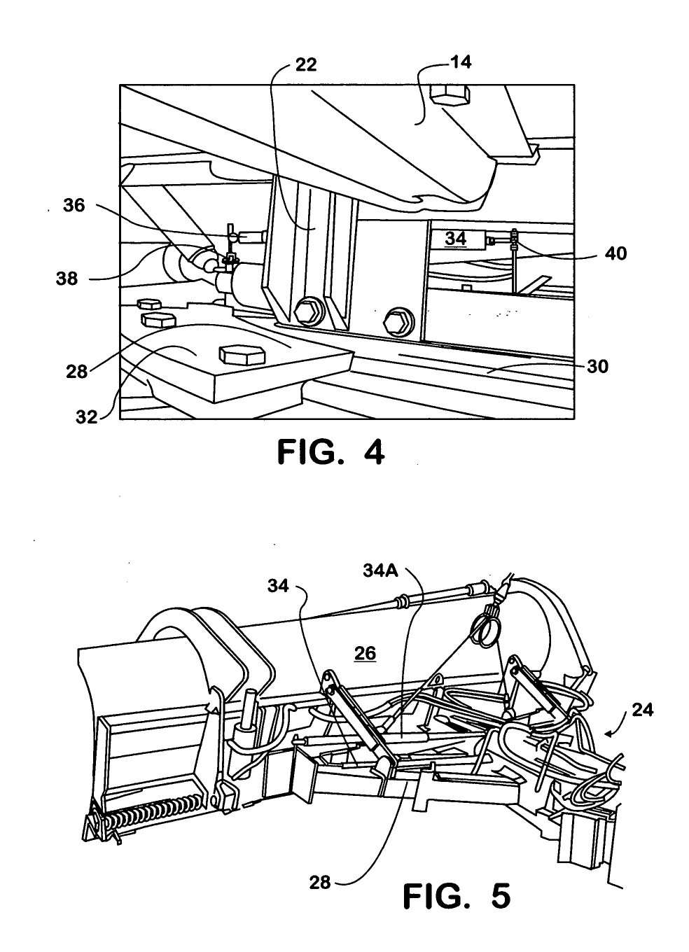

Referring now to FIGS. 1 and 4, the plow blade assembly 24 includes a plow blade 26 (see FIG. 1) movable with respect to a manifold 28. The manifold 28 includes a fixed mounting platform 30 that is generally perpendicular to the scraper-mounting bracket 22 and generally parallel with the frame 14, and a movable scraper platform 32 that slides with respect to the fixed mounting platform 30. The plow blade 26 (see FIG. 1) is attached to and positioned by the movable scraper platform 32 with respect to the frame 14.

A blade position sensor 34 is mounted on the plow blade assembly 24 to sense the position of the movable scraper platform 32 (therefore the position of the plow blade 26), with respect to a datum on the snow removal vehicle 10. A first end 36 of the position sensor 34 is attached to a bracket 38, which is fixed to the movable scraper platform 32, and a second end 40 is attached to the fixed mounting platform 30. Advantageously, the position sensor 34 is a linear sensor such as a potentiometer, however other position sensors are contemplated.

Unless stated otherwise, the angle of the plow blade 26 is measured with respect to the vehicle 10, such that at zero angle, the plane of the plow blade is generally transverse to the direction of movement of the vehicle. The angle of the plow blade 26 increases from zero as the blade is pivoted towards the left side or towards the right side of the vehicle 10 (for a vehicle driving on a road, towards the sides of the road). It is contemplated that other datum and measurement systems can be used.

The speed of the snow removal vehicle 10 and the angle of the plow blade 26 are factors that determine the direction that the plowed snow is thrown, as well as how far and how fast the plowed snow is thrown by the vehicle. For example, the faster the snow removal vehicle 10 moves, the further the plowed snow is thrown to the side of the vehicle. When the snow removal vehicle 10 runs faster or slower, the driver will typically adjust the plow blade 26 position to optimize the angle of the plow blade for a desired placement of removed snow. Further, when the snow removal vehicle 10 encounters snow drifts, the plow blade 26 may get inadvertently rotated from the desired orientation, requiring the driver to readjust the plow blade position.

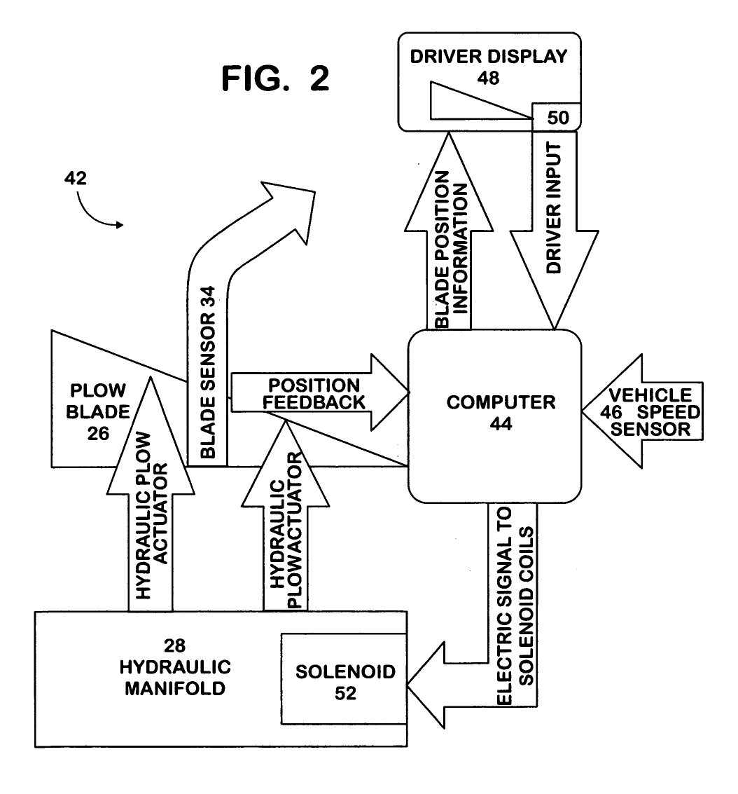

A flowchart of a position feedback control system 42 for measuring and controlling the plow blade 26 on the snow removal vehicle 10 is shown in FIG. 2. The control system 42 includes the blade position sensor 34 that is attached to the plow blade assembly 24 and a computer 44 that receives input from the blade position sensor. The computer 44 also receives input from a vehicle speed sensor 46.

Referring now to FIG. 2 and FIG. 3, a display panel 48 displays the actual position of the plow blade 26. The display panel 48 also includes an input receiver 50 for the user to input the desired position of the plow blade 26, which is input to the computer 44. It is contemplated that the input receiver 50 can be separate from the display panel 48. Using the vehicle speed input from the speed sensor 46, the desired position input from the input receiver 50, and the actual plow blade position input from the blade position sensor 34, the computer 44 calculates and adjusts the position or angle of the plow blade 26 by operating the manifold 28. It is contemplated that other factors, in addition to or in lieu of vehicle speed, can be used as input factors, for example, snow depth and ambient temperature, among others.

The computer 44 outputs to an actuator 52 on the manifold 28, which is advantageously a solenoid on a hydraulic manifold. The manifold 28 moves the movable scraper platform 32 with respect to the fixed mounting platform 30 to change the position of the plow blade 26. The position sensor 34 senses the position of the plow blade 26, and inputs the actual position of the plow blade to the computer 44.

The computer 44 implements a control function between the user input, the vehicle speed, the blade position sensor input, and the output to the actuator 52. Specifically, the computer 44 reads the user command for a desired blade position, reads the blade position sensor input and the vehicle speed input. The computer 44 converts the sensor inputs into actual blade angle using a calculation or table. Advantageously, the computer 44 uses the following equation to calculate actual blade angle using a potentiometer as a blade position sensor 34:

$$ϕ = {sin}^{- 1} \frac{1}{2 r \sqrt{{r}^{2} + {h}^{2}}} ( 2 {r}^{2} - 2 h Δ h - Δ {h}^{2} ) - {tan}^{- 1} ( \frac{r}{h} )$$

where φ is the plow blade angle, h is the potentiometer original length, Δh is the change in potentiometer length, and r is the fixed distance between pivot point (the point about which the blade pivots with respect to the vehicle) and the location of attachment of the potentiometer to the plow blade 26.

After the computer 44 computes the actual plow blade angle, it compares the actual blade angle to the desired blade angle. If there is a difference in the two values, the computer 44 actuates the actuator 52, such as the solenoid on the hydraulic manifold to correct any error in blade position. The computer 44 broadcasts the actual blade position to the display panel 48, which provides visual feedback of the blade position to the user.

It is contemplated that the user can dial in a desired position/angle at any time during operation of the snow removal vehicle, and the computer 44 will automatically compare and automatically correct the position of the plow blade 26. Further, it is contemplated that the desired position/angle can be set in the computer 44 until changed by the user, or for specific durations of time. Alternately, the user could input a desired angle as a function of the speed of the snow removal vehicle 10.

Referring now to FIG. 5, the control system 42 can also be used with a front-mounted plow assembly. Additionally, the control system 42 can incorporate a second blade position sensor 34A. The first blade position sensor 34 senses the left to right pivoting of the plow blade, while the second blade position sensor 34A senses the forward roll (downward towards the road) and backward roll (upwards away from the road) pivoting of the plow blade 26. It is contemplated that the control system 42 would include a second feedback loop similar to the feedback loop depicted in FIG. 2.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A plow blade assembly and position adjustment system comprising:
a plow blade mounted to a frame of a vehicle;
an actuator for adjusting the position of the plow blade relative to the frame of the vehicle;
a system for operating the actuator, including a blade position sensor for sensing an actual position of the plow blade and inputting the actual blade position to a computer, a user input receiver for the user to input a desired position of the plow blade to the computer, wherein the computer compares the actual position to the desired position and causes the actuator to move the plow blade to the desired position without user intervention.

2. The plow blade assembly and position adjustment system of claim 1 wherein the desired position is input by the user and stored by the computer.

3. The plow blade assembly and position adjustment system of claim 1 wherein the plow blade assembly further comprises a manifold having a fixed mounting platform and a moveable scraper platform that is moveable with respect to the fixed mounting platform, wherein the plow blade is fixed to the moveable scraper platform.

4. The plow blade assembly and position adjustment system of claim 1 wherein the actuator is a hydraulic actuator.

5. The plow blade assembly and position adjustment system of claim 1 wherein the blade position sensor is a linear sensor.

6. The plow blade assembly and position adjustment system of claim 5 wherein a first end of the linear sensor is operatively linked to the plow blade, and a second end of the linear sensor is operatively linked to the frame.

7. The plow blade assembly and position adjustment system of claim 1 further comprising a vehicle speed sensor for inputting a vehicle speed to the computer, wherein the desired blade position is dependent on the vehicle speed.

8. The plow blade assembly and position adjustment system of claim 1 further comprising a display panel for displaying the actual position of the plow blade.

9. The plow blade assembly and position adjustment system of claim 7 wherein the input receiver is on the display panel for the user to input the desired position of the plow blade.

10. The plow blade assembly and position adjustment system of claim 1 wherein the plow blade is moveable in multiple directions.

11. An automatic plow blade position control system for a vehicle having a plow blade mounted on a frame, comprising:
a computer;
a blade position sensor for sensing an actual position of the plow blade and inputting the actual position to the computer;
an input receiver for receiving a desired position of the plow blade from the user and inputting the desired position to the computer where the desired position input is stored;
an actuator for adjusting the position of the plow blade relative to the frame of the vehicle;
wherein the computer automatically compares the actual plow blade position with the desired plow blade position and actuates the actuator in response to a discrepancy between the desired plow blade position and the actual plow blade position to move the plow blade in the desired plow blade position without user intervention.

12. The control system of claim 11 wherein the desired position can be changed by the user at any time during operation of the vehicle.

13. The control system of claim 11 wherein the actuator is a hydraulic actuator.

14. The control system of claim 11 wherein the blade position sensor is a linear sensor.

15. The control system of claim 14 wherein a first end of the linear sensor is operatively linked to the plow blade, and a second end of the linear sensor is operatively linked to the frame.

16. The control system of claim 11 further comprising a vehicle speed sensor for inputting a vehicle speed to the computer, wherein the desired blade position is dependent on the vehicle speed.

17. The control system of claim 11 further comprising a display panel for displaying the actual position of the plow blade.

18. The control system of claim 11 further comprising an input receiver on the display panel for the user to input the desired position of the plow blade.

19. The control system of claim 11 wherein the computer uses a table to automatically compare the actual plow blade position with the desired plow blade position and to actuate the actuator in response to a discrepancy between the desired plow blade position and the actual plow blade position to move the plow blade in the desired plow blade position.

20. The control system of claim 11 wherein the computer uses the following equation to calculate the actual blade position using a linear sensor:
$$ϕ = {sin}^{- 1} \frac{1}{2 r \sqrt{{r}^{2} + {h}^{2}}} ( 2 {r}^{2} - 2 h Δ h - Δ {h}^{2} ) - {tan}^{- 1} ( \frac{r}{h} )$$
where φ is the actual plow blade angle, h is the original length of the linear sensor, Δh is the change in sensor length, and r is the fixed distance between a plow blade pivot point and a location of attachment of the potentiometer to the plow blade.
